(19) United States
(12) Patent Application Publication
(10) Pub. No.: US 2008/0294514 A1
(43) Pub. Date: Nov. 27, 2008

(54) SYSTEM AND METHOD FOR REMOTE DEPOSIT CAPTURE AND CUSTOMER INFORMATION GATHERING

(76) Inventor: Matthew A. Calman, Charlotte, NC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(21) Appl. No.: 11/752,515

(22) Filed: May 23, 2007

(51) Int. Cl. G06Q 99/00; G06Q 30/00

(52) U.S. Cl. 705/14; 705/1

(57) ABSTRACT

A system and method for integrated remote deposit capture and customer information gathering on a merchant's workstation where a plurality of checks are received from customers of the merchant and an image of each check is captured. Each check image is interrogated using image recognition software. A customer name and address on each check are identified. A list containing each identified customer name and address is created at the merchant's workstation and the list is stored. The list is useable by the merchant for marketing or gathering customer information where the customer information may include demographics of the customers. The customer information may also be used to identify checks from the same customer to determine a customer frequency useable to identify repeat customers. The list may be stored in a database. The marketing may include sending marketing materials from the merchant to the customers on the list.

### BACKGROUND

Embodiments of the present invention are related to remote deposit capture, and more specifically to simultaneous remote deposit capture and customer information gathering.

Existing commercial applications enable bank customers or merchants to capture images of checks and transmit these images to their bank for deposit in lieu of a physical visit and presentment of physical checks. These applications are generally knows as ‘remote deposit’ applications. Remote deposit is a form of self-service deposit that significantly reduces the handling and processing of paper check deposits by bank employees.

Commercial applications also exist that analyze images of checks to produce a data stream representing the preprinted, machine-printed, and handwritten information on the face of a check. These applications are generally known as “recognition” or “reco” applications and are used by banks and check processors. The efficacy of these recognition applications is generally accepted to be 30% to 80% capable of reliably rendering information from fields on a check image without human intervention. Recognition applications typically return a confidence score for each field analyzed. Factors affecting this capability include handwritten versus machine-printed or pre-printed information, image quality, and the use of field constraints and dictionaries to improve matching. If one desires 100% capture of the information from the face of a check, humans may need to be employed to key from sight of the image and complete any fields of interest. Recognition applications are time and computation intensive programs and are generally executed in a batch mode by banks after the images have been negotiated as a transaction to avoid delay in transaction clearing and settlement. Without the use of a recognition application, the only information available from a check is that which is encoded in magnetic ink character recognition (MICR) and optical character reader (OCR) font in the capture band on the front of the check.

However, merchants who accept check payments may desire identifying information from individuals or entities that they receive checks from. For example, merchants may desire information on the maker of the check such as their name or address. This information may be particularly useful for customers that operate a retail establishment. The information may be of value to merchants in knowing their customers/clients for marketing and communication activities. Further, merchants may not want to get this information from a bank or other source, but may prefer to control and generate their own database of information.

### SUMMARY

Embodiments of the present invention relate to a method for integrated remote deposit capture and customer information gathering on a merchant's self-service capture workstation that includes: receiving a plurality of checks from customers of the merchant; capturing an image of each check; interrogating each check image using image recognition software; identifying a customer name and an address on each check; creating a list containing each identified customer name and address at the merchant's workstation and storing the list; and using the list by the merchant for at least one of marketing or customer information.

Further, embodiments of the present invention relate to a system for integrated remote deposit capture and customer information gathering at a merchant site that includes: a workstation and a storage device. The workstation is capable of: receiving a plurality of checks from customers of the merchant; capturing an image of each check; interrogating each check image using image recognition software; identifying a customer name and an address on each check; creating a list containing each identified customer name and address at the merchant's workstation; and storing the list in the storage device, wherein the list is useable by the merchant for at least one of marketing or customer information.

Moreover, embodiments of the present invention relate to an apparatus, the apparatus comprising a storage device containing instructions stored therein, the instructions when executed causing a merchant workstation to perform: receiving a plurality of checks from customers of the merchant; capturing an image of each check; interrogating each check image using image recognition software; identifying a customer name and an address on each check; creating a list containing each identified customer name and address at the merchant's workstation; and storing the list, wherein the list is useable by the merchant for at least one of marketing or customer information.

In addition, embodiments of the present invention relate to a system for integrated remote deposit capture and customer information gathering on a merchant's self-service capture workstation that includes: means for receiving a plurality of checks from customers of the merchant; means for capturing an image of each check; means for interrogating each check image using image recognition software; means for identifying a customer name and an address on each check; means for creating a list containing each identified customer name and address at the merchant's workstation and storing the list; and means for using the list by the merchant for at least one of marketing or customer information.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of a system for integrated remote deposit capture and customer information gathering at a merchant site according to an example embodiment of the present invention;

FIG. 2 is a flowchart of a process for integrated remote deposit capture and customer information gathering at a merchant site according to an example embodiment of the present invention; and

FIG. 3 is a flowchart of a process for using customer data in a system for integrated remote deposit capture and customer information gathering at a merchant site according to an example embodiment of the present invention.

### DETAILED DESCRIPTION OF THE INVENTION

The following detailed description of embodiments refers to the accompanying drawings, which illustrate specific embodiments of the invention. Other embodiments having different structures and operation do not depart from the scope of the present invention.

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the present invention, a remote deposit platform is integrated with recognition capabilities on a merchant's self-service capture workstation. Recognition could be run either at the point of capture when image quality is typically assessed, or deferred until a later time. Any fields which could not be reliably recognized by algorithm (e.g., with a confidence score exceeding a defined threshold) may be keyed from sight by the merchant's operator, either at the point of capture or at a later time. The resulting stream of information on the depositing merchant's workstation would be stored to a database for use by the depositing merchant. By employing a list or database of known, past customers, matching could significantly improve the recognition rate, reducing the workload for manual entry and keying.

Embodiments according to the present invention provide the recognition and storing of the names and addresses of the depositing merchant's customers. For example, a depositing merchant who operates a retail store and accepts check payments would have the opportunity to capture full name and address information of their customers paying by check. This information could be used for targeted marketing or demographic research and would not be obtainable otherwise unless through manual inspection and data entry of check fields.

By pairing these two functions, merchants and retail operators can generate new information on their customers with only the incremental labor to key unrecognized fields. However, as noted previously, by employing a dictionary of known, past customers matching could significantly improve the recognition rate, reducing the workload for keying.

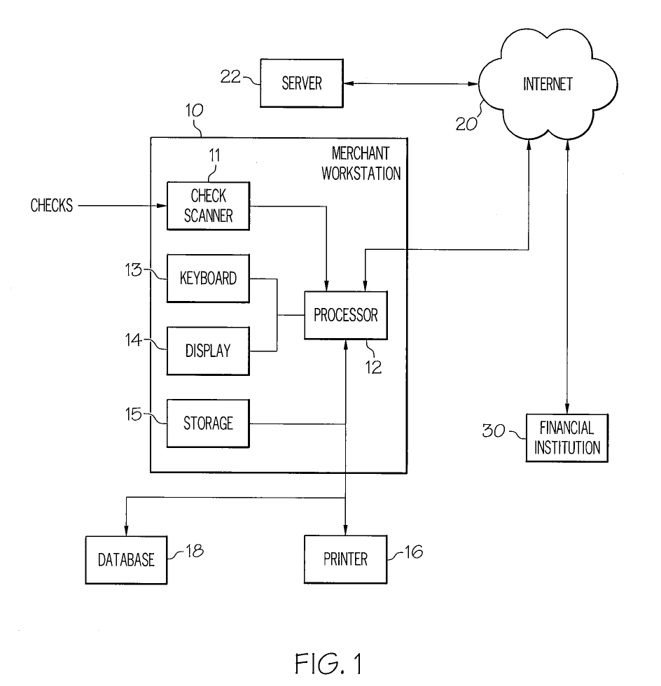

FIG. 1 shows a diagram of a system for integrated remote deposit capture and customer information gathering at a merchant site according to an example embodiment of the present invention. The system includes a merchant workstation 10 that may include a processor 12, a check scanner 11 for scanning received customer checks, a keyboard 13, a display 14 and a storage device 15. The merchant workstation 10 may be interconnected to the Internet 20, a database 18 and capable of performing remote deposit of the scanned checks with a financial institution 30 over a network such as the Internet 20. Further, the merchant workstation 10 receives checks for processing and may be connected to a printer 16.

A server 22, interconnected to the Internet 20, may provide the ability to download software onto the merchant workstation 10 that supports integrated remote deposit capture and customer information gathering processing. Embodiments of the present invention support both thick client remote deposit applications, where remote deposit and client information gathering software is installed on the merchant workstation 10 via a compact disk (CD), and thin client remote deposit applications, where remote deposit and client information gathering software may be loaded on a server 22 and downloaded to a merchant workstation 10 over the Internet 20 from the server 22. Moreover, embodiments of the present invention include integrated remote deposit capture and customer information gathering being performed with the help of software installed on the merchant's workstation 10 and the server 22.

A person or merchant at the merchant workstation 10 loads checks that have been received from customers into the check scanner 11 for capturing an image of each check. Using software loaded on the processor 12, each check is interrogated using image recognition software and a customer name and address are identified for each check. The processor 12 may then create a list containing each identified customer name and address and store the list in storage device 15, or in database 18. Further, the list may be printed using printer 16. Moreover, a merchant may generate a mailing list using the customer name and address list and by using any type of mailing or sending means, send marketing information to each of the customers on the list. The marketing materials may be sent via the mail, via email or the Internet 20, or by any other transmission means. The transmission of the marketing materials may be done manually or performed automatically by the workstation after the checks have been scanned and interrogated.

The list may be created and stored and used at a later date by the merchant for marketing activities or customer information gathering such as determining locations of customers, determining name changes of customers, determining address changes of customers, etc. The stored list may also be time-stamped and compared with previously stored lists to denote changes or other information such as the last time a check was received from a particular customer.

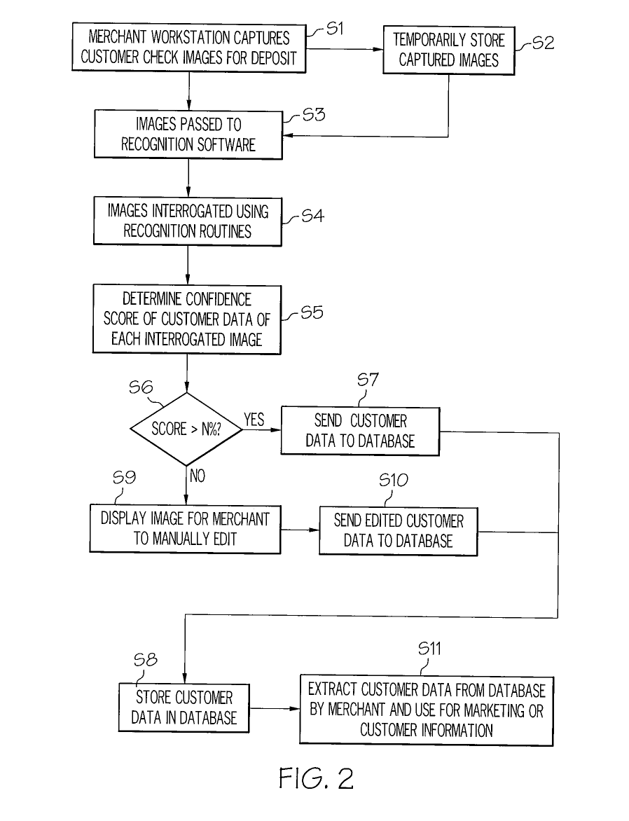

FIG. 2 shows a flowchart of a process for integrated remote deposit capture and customer information gathering at a merchant site according to an example embodiment of the present invention. Customer check images are captured for deposit at a merchant workstation S1. The captured images may be temporarily stored for use later S2. The images may be passed to recognition software S3. Recognition routines and/or algorithms on the merchant workstation may be used to interrogate each of the images S4. A confidence score for customer data in each interrogated image is determined S5. The confidence score relates to how recognizable the customer data is on the check image. It may be determined if the confidence score of each image is larger than a certain percentage of recognition S6, and if so, the image is determined to be a high confidence image and customer data from the high confidence image is sent to the database S7 and stored S8 in a data format. If the confidence score is not larger than a certain percentage of recognition, the customer data may be displayed for the merchant to manually edit S9, and then the edited customer data is sent to a database S10 and stored S8. A merchant may then extract the stored customer data from the database and use this data for marketing purposes and customer information gathering S11. According to embodiments of the present invention, a process for integrated remote deposit capture and customer information gathering at a merchant site may be performed in real time, where corrections are keyed as each check moves through a scanner, or in a batch mode where several (or all) checks are scanned and then corrections for each check are keyed.

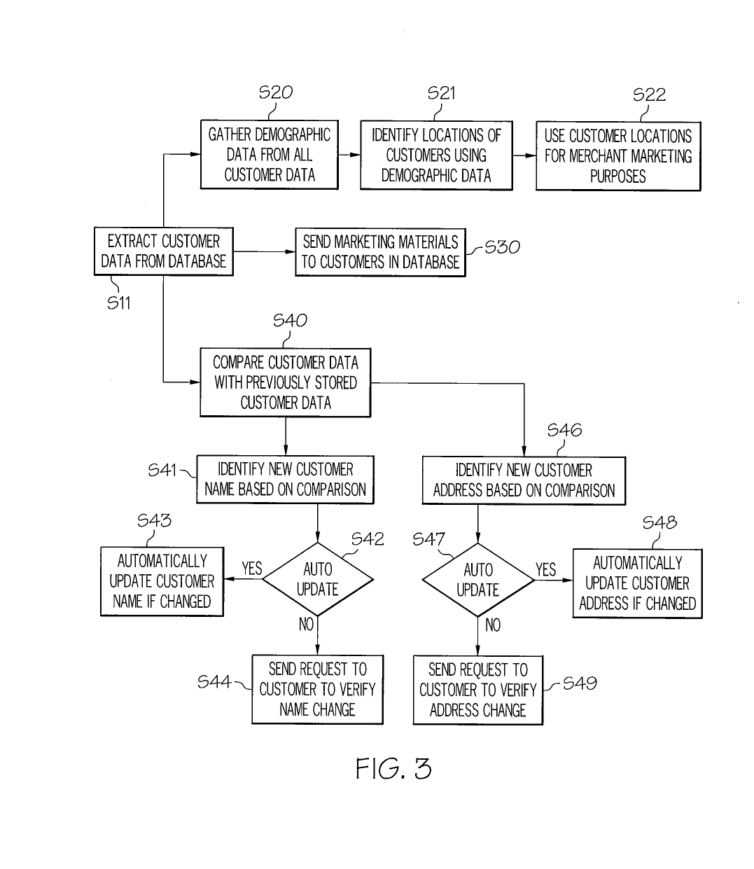

FIG. 3 shows a flowchart of a process using customer data in a system for integrated remote deposit capture and customer information gathering at a merchant site according to an example embodiment of the present invention. A merchant may extract the customer data from the database S11, and use this customer data for any of several purposes. For example, the merchant may use the extracted customer data to gather demographic data from all the stored customer data S20. This may include using the demographic data to identify areas or locations of customers S21. In this regard, the merchant may generate graphical diagrams that depict the locations of customers and the concentration of customers in particular locations. For example, a pie chart containing portions with specific zip codes may be generated and the size of each portion on the pie chart determined by the number of checks received from customers in that zip code. In another example, customer locations may be plotted on a map with the merchant site located in the center of the map whereby the merchant is able to determine how far away the various customers are from the merchant site, as well as which areas have a higher concentration of customers that the merchant has received checks from.

A merchant may also use the customer data to identify how many checks have been received from a specific customer. After customer locations have been identified, the merchant may use this information for merchant marketing purposes S22 where the merchant may send marketing materials to the customers at these locations and/or may send marketing materials to locations where the merchant has not received a substantial number of customer checks S22. The merchant may also extract customer data from the database S11 and then use this information to directly send marketing materials to customers in the database S30.

Moreover, the merchant may extract the customer data from the database S11 and use the workstation to compare the customer data with previously stored customer data S40. This allows the merchant to identify if a check has been received from a customer with a new name S41. The customer bank account number on the check may be the same for the two checks (currently received and previously stored), but a name on each check may be different. The merchant may have software on the workstation that allows the merchant to select whether a customer's name should be automatically updated S42 if a new customer name has been identified S41. If automatic update is selected, a customer's name may be automatically updated to the newly received customer name S43 in a master customer information file or database. If the merchant has set up the workstation to not automatically update a customer name if a change is detected, a request to the customer may be sent asking the customer to verify the name change detected on the most recently received check S44. The workstation may automatically send a request to the customer to verify the name change, or may simply present information to the merchant alerting the merchant that a request to the customer for verification of the name change should be sent.

Similarly, the customer data may be compared with previously stored customer data and a new customer address detected based on the comparison S46. Similar to the name change, a customer account number common to both checks may be used to identify a particular customer where an address on the currently received check is compared with an address that has been previously stored for this particular customer. The merchant may have set up the workstation to automatically update customer information or to simply display a message if an address change is detected S47. If the workstation is set up to automatically update the customer address, the customer address may be automatically changed and updated in a master customer information file or database S48 upon the determination that on the most recently received check of a customer, the address has been changed from a previously received check. If automatic update has not been selected S47, the workstation may automatically send a request to the customer to verify the address change, or may simply present information to the merchant alerting the merchant that a request to the customer for verification of the address change should be sent S49.

Embodiments of systems and methods for integrated remote deposit capture and customer information on a merchant's workstation according to the present invention are advantageous for several reasons. For example, embodiments according to the present invention allow merchants the opportunity to extract source of information on the maker of the check such as their name and address. This information is valuable to the merchants since in knowing their customers, merchants may provide more targeted marketing and communication activities to existing and potential customers. This information would only otherwise be available through manual inspection and manual data entry of check fields, which can be time consuming and labor intensive. Moreover, embodiments of the present invention support both thick client remote deposit applications, where remote deposit and client information gathering software is installed on the merchant machine via a compact disk (CD), and thin client remote deposit applications, where remote deposit and client information gathering software may be loaded on a server and downloaded to a merchant workstation over the Internet from the server. Moreover, embodiments of the present invention allow automatic updating of customer name and address information as well as the ability to identify customer locations, concentrations, distance from merchant site, and frequency of checks received, allowing a merchant to intelligently target marketing activities.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method for integrated remote deposit capture and customer information gathering on a merchant's self-service capture workstation comprising:
receiving a plurality of checks from customers of the merchant;
capturing an image of each check;
interrogating each check image using image recognition software;
identifying a customer name and an address on each check;
creating a list containing each identified customer name and address at the merchant's workstation and storing the list; and
using the list by the merchant for at least one of marketing or customer information.

2. The method according claim 1, wherein the customer information comprises demographics of the customers.

3. The method according claim 1, further comprising using the customer information to identify checks from the same customer to determine a customer frequency useable to identify repeat customers.

4. The method according to claim 1, further comprising storing the list in a database.

5. The method according to claim 1, wherein the marketing further comprises sending marketing materials from the merchant to the customers on the list.

6. The method according to claim 1, further comprising comparing the customer information with previously stored customer information and identifying a customer name change.

7. The method according to claim 1, further comprising comparing the customer information with previously stored customer information and identifying a customer change of address.

8. The method according to claim 1, further comprising sending the captured images of each check to a financial institution after the capturing.

9. The method according to claim 1, wherein the integrated remote deposit capture and customer information gathering is performed with the help of software installed on the merchant's self-service capture workstation and a server.

10. The method according to claim 1, wherein the integrated remote deposit capture and customer information gathering is performed with the help of software installed on the merchant's self-service capture workstation.

11. The method according to claim 10, wherein the software is installed on the merchant's workstation from a compact disk (CD) inserted into the workstation.

12. The method according to claim 10, wherein the software is installed on the merchant's workstation by downloading from a server over the Internet.

13. A system for integrated remote deposit capture and customer information gathering at a merchant site comprising:
a workstation; and
a storage device,
wherein the workstation is capable of:
receiving a plurality of checks from customers of the merchant;
capturing an image of each check;
interrogating each check image using image recognition software;
identifying a customer name and an address on each check;
creating a list containing each identified customer name and address at the merchant's workstation; and
storing the list in the storage device, and
wherein the list is useable by the merchant for at least one of marketing or customer information.

14. The system according claim 13, wherein the customer information comprises demographics of the customers.

15. The system according to claim 13, wherein the marketing further comprises sending marketing materials from the merchant to the customers on the list.

16. The system according to claim 13, wherein the workstation compares the customer information with previously stored customer information and identifies a customer name change.

17. The system according to claim 13, wherein the workstation compares the customer information with previously stored customer information and identifies a customer change of address.

18. The system according to claim 13, wherein the workstation sends the captured images of each check to a financial institution.

19. The system according to claim 13, wherein the integrated remote deposit capture and customer information gathering is performed with the help of software installed on the workstation and a server.

20. The system according to claim 13, wherein the integrated remote deposit capture and customer information gathering is performed with the help of software installed on the workstation.

21. The system according to claim 20, wherein the software is installed on the workstation from a compact disk (CD) inserted into the workstation.

22. The system according to claim 20, wherein the software is installed on the workstation by downloading from a server over the Internet.

23. An apparatus, the apparatus comprising a storage device containing instructions stored therein, the instructions when executed causing a merchant workstation to perform:
receiving a plurality of checks from customers of the merchant;
capturing an image of each check;
interrogating each check image using image recognition software;
identifying a customer name and an address on each check;
creating a list containing each identified customer name and address at the merchant's workstation; and
storing the list,
wherein the list is useable by the merchant for at least one of marketing or customer information.

24. The apparatus according claim 23, wherein the customer information comprises demographics of the customers.

25. The apparatus according claim 23, further performing using the customer information to identify checks from the same customer to determine a customer frequency useable to identify repeat customers.

26. The apparatus according to claim 23, further comprising storing the list in a database.

27. The apparatus according to claim 23, wherein the marketing further comprises sending marketing materials from the merchant to the customers on the list.

28. A system for integrated remote deposit capture and customer information gathering on a merchant's self-service capture workstation comprising:
means for receiving a plurality of checks from customers of the merchant;
means for capturing an image of each check;
means for interrogating each check image using image recognition software;
means for identifying a customer name and an address on each check;
means for creating a list containing each identified customer name and address at the merchant's workstation and storing the list; and
means for using the list by the merchant for at least one of marketing or customer information.

29. The system according to claim 28, further comprising means for storing the list in a database.

30. The system according to claim 28, wherein the marketing further comprises sending marketing materials from the merchant to the customers on the list.

31. The system according to claim 28, further comprising means for sending the captured images of each check to a financial institution after the capturing.
